(19) United States
(12) Patent Application Publication
(10) Pub. No.: US 2010/0237797 A1
(43) Pub. Date: Sep. 23, 2010

(54) HIGH-INTENSITY DISCHARGE LAMP AND LIGHTING DEVICE

(75) Inventors: Hiroyuki OGATA, Yokosuka-Shi (JP); Katsuya Otani, Yamato-Shi (JP); Kazuyoshi Okamura, Yokohama-Shi (JP)

Correspondence Address: DLA PIPER LLP US, P. O. BOX 2758, RESTON, VA, 20195, US

(73) Assignee: OSRAM-MELCO TOSHIBA LIGHTING LTD., Yokosuka-Shi (JP)

(21) Appl. No.: 12/717,156

(22) Filed: Mar. 4, 2010

(30) Foreign Application Priority Data
Mar. 19, 2009 (JP) 2009-068258

(51) Int. Cl. H01J 61/36; H05B 41/36

(52) U.S. Cl. 315/291; 313/623

(57) ABSTRACT

A high-intensity discharge lamp including an arc tube provided with a heat-resistant translucent discharge vessel forming a discharge space, an electrode structure, a discharge medium charged in the discharge vessel, the discharge medium being composed of a light-emitting metal including mercury and a starting gas, a support member electrically connected with the electrode structure of the arc tube and holding the arc tube and an outer bulb having the arc tube disposed therein along a tube axis and sealed with a support member at an end portion thereof. The electrode structure has an electrode shaft hermetically sealed at each of opposed end portions of the discharge vessel and having a tip portion disposed in the discharge vessel, a coiled electrode wound around the tip portion of the electrode shaft disposed in the discharge vessel, and a recessed portion or a protruding portion formed on the electrode shaft spaced from the coiled electrode. A lighting device with the high-intensity discharge lamp is also described.

### CROSS REFERENCE TO RELATED APPLICATIONS

This application is based upon and claims the benefit of priority from the prior Japanese Patent Application No. 2009-068258 filed in Japan on Mar. 19, 2009; the entire contents of which are incorporated herein by reference.

### BACKGROUND OF THE INVENTION

1. Field of the Invention

The present invention relates to a high-intensity discharge lamp in which at least a pair of electrodes are provided so as to face each other in an arc tube having a heat-resistant translucent discharge vessel and which is charged with a discharge medium including mercury, and to a lighting device using the discharge lamp.

2. Description of the Related Art

A high-intensity discharge lamp, such as a metal halide lamp, composed of an arc tube, which is sealed as a main component in a translucent outer bulb or the like through a support member constituting a power feeder. The arc tube is a heat-resistant translucent vessel made of ceramics or silica glass having a straight tube shape, an oblong shape or the like, in which a pair of electrodes is opposed to each other, each electrode being provided on a tip portion of a lead-in conductor in, un which The vessel. The arc tube is charged with a discharge medium, for example, mercury, halide of light-emitting metal and dilution gas.

The high-intensity discharge lamp is turned on by being connected with a choke type ballast using a wire-wound transformer which has conventionally been known in luminaires, or an electronic ballast using an inverter or the like which has recently been developed. The electronic ballast provides high-pulse voltages and thus achieves high startability as well as small and compact size but is disadvantageously expensive. On the contrary, the choke type ballast is inferior in electrical performance such as pulse voltages to the electronic ballast described above but is of lower price and has a longer lifetime than a lamp. Accordingly, the choke type ballast is still frequently used.

In the case of a high-intensity discharge lamp to be turned on with the choke type ballast, a relatively long period is required to start up a low starting voltage type discharge lamp which has been applied most widely. To shorten the starting period, conventionally, the following techniques have been used, for example: means of attaching a start assist electrode or an enhancer for radiation of ultraviolet ray, means of facilitating generation of glow discharge by charging a radioactive element and inducing initial electrons and a technique of attaching a start assist element such as a proximity conductor to facilitate a shift from glow discharge to arc discharge.

In a high-intensity discharge lamp of this type, it is known that a relatively long period is required for start-up until obtaining prescribed light emission and electrical characteristics, such as vaporization of a metallic substance for light emission or for adjusting electrical characteristics of a lamp, which is charged in an arc tube.

### SUMMARY OF THE INVENTION

The inventors of the present invention discovered that after various studies in an attempt of shortening a starting period of the high-intensity discharge lamp, a possible cause of too long starting period is due to an electrode structure and that improvement in the electrode structure can improve startup characteristics.

Specifically, in the case of the high-intensity discharge lamp, a lamp is attached onto a socket in the vertical state, referred to as a base-up state where a base is located upward or a base-down state where a base is located downward, or in an inclined state. In this case, mercury or metal halide charged in an arc tube evaporates during high-temperature operation (turning-on) and ionized by discharge energy for light emission and, after turning-off with energization stopped, is placed into a charged state at room temperature, that is, mercury remains in a liquid state and metal halide remains in a solid state in the arc tube.

FIGS. 8 and 9 illustrate X-ray observation results of progress of mercury with time after turning-off of a lamp. FIG. 8 is a partial longitudinal front view illustrating essential parts of an arc tube La of a conventional metal halide lamp having a ceramic discharge vessel. FIGS. 9A to 9D are descriptive views illustrating deposit states of mercury on an electrode structure of an upper electrode of FIG. 8 with time after the lamp is turned off. In FIG. 8, reference character B indicates a swelling portion B1 forming a discharge space, and reference character B2 indicates a tubular portion having both ends (FIG. 8 illustrates only one end; however, the other end is structured in the same way. The same is applicable in the description below.), each inner diameter of which is smaller than that of the swelling portion B1.

The discharge vessel B is provided with an electrode structure D (FIG. 9A) comprised of an electrode shaft D1 and an electrode D2. The electrode shaft D1 is a rod element which is made of tungsten (W) or niobium (Nb) and penetrates through the small-diameter tubular portion B2 and which is hermetically sealed on outer-end portion side (not illustrated) thereof through heat-resistant airtight adhesive. The electrode D2 is formed in a coil shape by closely-winding a tungsten (W) wire around a tip portion of the other end disposed in the swelling portion B1 of the electrode shaft D1 approximately 5 turns.

Reference character D3 in FIG. 9 indicates a coil formed by a molybdenum (Mo) fine wire wound around the electrode shaft D1 and is provided to ensure that the electrode shaft D1 passes through a center of the small-diameter tubular portion B2. The discharge vessel B is charged with a discharge medium including liquid mercury H, a metal halide and a starting gas.

The arc tube La is installed on a power feeder, which usually also serves as a power supply portion, sealed in an outer bulb (not illustrated) formed by hard glass or the like and electrically connected with a base joined to an outer bulb end portion.

As described above, in the high-intensity discharge lamp attached onto the socket in the base-up or base-down state within a luminaire, the mercury and metal halide charged in the arc tube La evaporate during a high-temperature operation (turning-on) under an energization state and is ionized by discharge energy for light emission. After turning-off when energy is stopped, the charged mercury and metal halide are maintained at room temperature state. For example, mercury remains in a liquid state and metal halide remains in a solid in the arc tube La, respectively.

At this time, a portion whose temperature drops earliest in the arc tube is the electrode shaft D1 portion constituting the electrode structure D. The portion projects into and exposed to a discharge space from the swelling portion B1 and the small-diameter tubular portion B2 of the discharge vessel B and has a smallest heat capacity. The vaporized one of the mercury H with high vapor pressure is deposited on the electrode shaft D1 portion rapidly cooled (FIG. 9B—4 minutes after turning-off) from one to another. In the electrode structure D positioned on an upper side, the mercury H deposited and cooled to be liquefied on the electrode shaft D1 portion falls down the electrode shaft D1 portion by gravitation resulting from an increasing number of liquefied droplets and gathers on a top face of a stepped portion having a large diameter formed by an end of the coiled electrode D2 (FIG. 9C—6 minutes after turning-off). When the liquefied mercury H further increases, the mercury falls down by gravitation and covers a surface of the coiled electrode D2 including a tip portion thereof (FIG. 9D—8 minutes after turning-off). However, particularly, mercury H having high surface tension maintains this state until the next turning-on without falling down from the coiled electrode D2 portion due to a low magnitude of vibration even if the mercury is stored in a teardrop form.

Herein, it has been proven that when a tip portion of the coiled electrode D2 which is a discharge trigger is covered with the gathering mercury H, a part of energy required for discharge start at lamp start-up runs short due to absorption in the mercury H and a relatively long period is required for start-up. Further, it has been proven that because a relatively long period is required for start-up, sputtering of electrode material increases, which causes degradation of characteristics such as lumen maintenance factor of a lamp.

In the electrode structure D positioned on a lower side, as described above, vapor of mercury H deposited on the electrode shaft D1 after the lamp is turned off liquefies, falls down the electrode shaft D1 by dead weight thereof and gathers on a root portion (hermetically sealed portion, for example) of the electrode shaft D1. Accordingly, the structure illustrated in FIG. 8 poses no special problem; however a lamp in which an electrode shaft having a main electrode such as a high-intensity mercury lamp and an electrode shaft having an auxiliary electrode for start-up are proximately in parallel, as described later, may cause no lighting of a lamp due to falling-down mercury, which results from the mercury gathering over between the root portions of both the electrodes, thereby to short a lamp circuit.

It is an object of the present invention to provide a lamp which is equipped with an electrode structure having a coiled electrode on an electrode shaft and which is charged with a discharge medium including mercury therein and in particular, a high-intensity discharge lamp having high startability by preventing mercury from adhering to a tip portion of the electrode, and to provide a lighting device capable of facilitating start-up of the high-intensity discharge lamp using an inexpensive ballast.

According to a first aspect of the present invention, there is provided a high-intensity discharge lamp including an arc tube provided with: a heat-resistant translucent discharge vessel forming a discharge space; an electrode structure including an electrode shaft hermetically sealed at each of opposed end portions of the discharge vessel and having a tip portion disposed in the discharge vessel, a coiled electrode wound around the tip portion of the electrode shaft disposed in the discharge vessel, and a recessed portion or a protruding portion formed on the electrode shaft spaced from the coiled electrode; and a discharge medium charged in the discharge vessel, the discharge medium being composed of a light-emitting metal including mercury and a starting gas.

According to the first embodiment of a high-intensity discharge lamp further comprising: a support member electrically connected with the electrode structure of the arc tube and retaining the arc tube; and an outer bulb having the arc tube disposed therein along a tube axis and sealed with a support member at an end portion thereof.

According to such an embodiment of the present invention, in a high-intensity discharge lamp which is turned on in a vertical or inclined state using a base-up or base-down structure, after the lamp is turned off, mercury vaporized in an arc tube adheres to an electrode shaft having the smallest heat capacity and cooled to be liquefied. However, a flow of the liquefied mercury is stored by a recessed portion or a protruding portion formed on the electrode shaft, thereby to suppress liquefied mercury preventing a discharge from adhering to a tip portion of the coiled electrode.

The present invention can be effectively applied to, particularly, an embodiment of a high-intensity discharge lamp using a small ceramic discharge vessel. That is to say, according to an embodiment of the present invention, the discharge vessel, made of ceramic material, is provided with a substantially spherical swelling portion and small-diameter tubular portions on both ends of the swelling portion formed integrally therewith. The electrode structure is inserted into the small-diameter tubular portion and hermetically sealed by a heat-resistant sealant.

In such a high-intensity discharge lamp, an inner diameter of an opening for inserting the electrode structure, of an end portion of the discharge vessel is small; therefore, a wire diameter of the coil electrode wound around the electrode shaft cannot be increased. Accordingly, by forming the recessed portion or the protruding portion on the electrode shaft to store liquefied mercury therein or thereon, the liquefied mercury which may block a discharge can be inhibited from adhering to the tip portion of the coiled electrode under a state where the inner diameter of the opening of the tip portion of the discharge vessel remains small. Thus, in addition to shortening the start time of the high-intensity discharge lamp, sputtering of the electrode material can be suppressed, thereby to suppress degradation of the lumen maintenance factor.

In describing the present invention and the following respective embodiments, unless otherwise specified, definitions of terms and technical meanings are as described below.

As materials of the discharge vessel of the arc tube, the following materials are available: sapphire, ceramics such as aluminum oxide (alumina), oxide of yttrium-aluminum-garnet (YAG), yttrium oxide (YOX) and aluminum nitride (AlN), highly heat-resistant translucent material formed from hard glass such as silica glass, orosilicate glass and aluminosilicate glass, or highly corrosive-resistant material formed from halide.

The translucent material may be a light diffusion material regardless of whether or not the material is transparent, provided that the material has appropriate light transmission capability of transmitting the light generated by a discharge and emitting the light to the outside. The portion that hardly receives a radiation by a discharge such as vessel end portion may use a light-shielding material.

A shape of the longitudinal section 0f the discharge vessel is oblong/elliptical, spherical, tubular, complex thereof or the like and opening end portions facing each other are hermetically sealed to form sealed portions. The sealed portion may be sealed with a plug made of metal, ceramics, cermet or the like or sealant such as heat-resistant sealant in use of ceramics, or may be sealed by heat-melting the opening portion in use of silica glass or the like.

In the case of a ceramic discharge vessel, the electrode is constructed by connecting a plurality of members, for example, two members in which an electrode shaft made of tungsten (w) or doped tungsten provided with an electrode is directly welded in series, or four members welded in series through an intermediate member made of molybdenum (Mo) or cermet and the lead-in conductor between the two members, with an outer conductor formed by a rod, a pipe or the like also serving as a sealing member made of sealing metal such as niobium (Nb), tantalum (Ta), titanium (Ti), zirconium (Zr), hafnium (Hf) and vanadium (V).

In the case of a discharge vessel made of silica glass, a foil material or a wire material of molybdenum (Mo) or tungsten (W) is used as a sealing metal. By connecting the electrode shaft made of the wire material of molybdenum (Mo) or tungsten (W), the inner conductor and the outer conductor with the sealing metal, a comb-shaped electrode is constituted.

A material of the electrode structure may be appropriately selected according to a coefficient of thermal expansion of that of each of a discharge vessel and sealant. The lead-in conductor made of halogen-resistant material such as the molybdenum (Mo) or cermet suppresses a difference between coefficients of thermal expansion of the electrode member and the sealing metal as well as heat transfer from the hot electrode portion to the sealed portion.

The discharge medium includes a light-emitting substance such as mercury or a compound thereof, for example, metal halide and amalgam. The metal halide may use any one type or a plurality of types of the following known materials: for example, sodium (Na), thallium (TI), indium (In), lithium (Li) and cesium (Cs) or rare-earth metal such as dysprosium (Dy), holmium (Ho), thulium (Tm), scandium (Sc), neodymium (Nd) and cerium (Ce) as light-emitting metal and iodine (I), bromine (Br), chlorine (Cl) and fluorine (F), according to light-emitting efficiency, light emission characteristics such as color rendering properties and light-emitting color, lamp power or an internal volume of a discharge vessel.

In addition, as dilution gas, neon (Ne) or argon (Ar) is sealed; however, other dilution gas may be sealed as needed. The dilution gas is a starting gas and a buffering gas and is sealed in the discharge vessel so as to provide a pressure of approximately 1 atmospheric pressure or higher.

As the outer bulb, A type, AP type, B type, BT type, ED type, R type, T type and the like are available, which are made of glass such as hard glass, for example, silica glass and orosilicate glass and semihard glass or a translucent heat-resistant material. A mount (support member) holding the arc tube is inserted from the opening of the end portion and the opening is heated with a burner to be directly melted and closed or a stem is used to form a sealed portion. In the case of an outer bulb of T (straight tube) shape, the sealed portion may be formed at both ends thereof. In addition, the outer bulb inside may be in either of a vacuum atmosphere or an inert gas atmosphere where dilution gas such as nitrogen (N2) or argon (Ar) is sealed therein.

The support member has a portion sealed in the sealed portion which requires a material having high hermetical properties and fitness to the outer glass. Accordingly, it is appropriate to constitute a feeder line portion in an outer tube, a sealing member portion of the sealed portion, an external lead portion led out to the outside of the outer tube and the like by connecting a plurality of materials. It is sufficient if specifications such as materials and dimensions are properly selected according to type, electric power, weight, outer bulb material and the like.

The feeder line portion of the support member inside the outer bulb, made of metal material such as molybdenum (Mo) or tungsten (w), is electrically connected with the outer conductor at both ends of the arc tube for power supply and for support member for mounting and retaining the arc tube along a tube axis.

Further, there may be provided an intermediate tube surrounding the arc tube, which is made of a heat-resistant translucent material of substantially same ceramics, silica glass or hard glass as the vessel; however, the intermediate tube is not an essential member. The intermediate tube provides enhanced light-emitting characteristics such as high efficiency and high color rendering properties by enabling thermal insulation of the arc tube and facilitating operation of the light-emitting metal as well as protection against breakage of the arc tube.

According to an embodiment of the present invention, there is provided a high-intensity discharge lamp including: a recessed portion or the protruding portion formed on an electrode shaft, in which the recessed portion or the protruding portion is formed by a coil wound around the electrode shaft.

That is to say, by winding a coil around the electrode shaft spaced from the coiled electrode of the tip portion, a protruding portion to be formed by a coil wound the electrode shaft and a protruding portion to be formed by no presence of a coil are formed on the electrode shaft. The recessed portion can be used as a mercury storage portion for storing mercury falling down the electrode shaft after the lamp is turned off.

According to another embodiment of the present invention, there is provided a high-intensity discharge lamp, in which the recessed portion or the protruding portion on the electrode shaft is formed by partially varying an outer diameter of the electrode shaft.

That is to say, at the electrode shaft portion spaced from the coiled electrode, there are provided either one or both of a recessed portion having a smaller diameter than that of the electrode shaft and a protruding portion having a larger diameter. Further, by forming an inclined surface on the recessed portion or the protruding portion, these portions are made to serve as a mercury storage portion or a mercury fall-down portion. The recessed portion and the protruding portion formed on the electrode shaft can store liquefied mercury or can be made to fall down. The recessed portion and the protruding portion may be formed integrally with an electrode shaft or may be integrally formed by joining members having different diameters from each other.

According to still other embodiment of the present invention, there is provided a lighting device including: a lighting device body, the high-intensity discharge lamp in either one of the embodiments attached to the lighting device body and a lighting circuit device for turning on the high-intensity discharge lamp.

The lighting device (luminaire) according to the respective embodiments can shorten a start-up period because of no deposition of mercury to the tip portion of the coiled electrode of the lamp.

The lighting device according to the present invention includes, in a broad sense, all apparatuses/devices that use light emission of the high-intensity discharge lamp for some purpose. For example, the present invention is applicable to a compact self-ballasted high-intensity discharge lamp, an ordinary luminaire, a luminaire for facilities such as sports facilities, public facilities and factories, a light source apparatus for ceiling headlight optical fiber, an image projection apparatus, a photochemical apparatus and others.

According to still other embodiment of the present invention, a lighting device includes choke type ballast in a lighting circuit for turning on a lamp.

The lighting device according to the respective embodiments can shorten a start-up period under a turning-on state with choke type ballast.

In the present invention, at least one pair of electrode structures are provided; however, even only one of the pair of electrode structures may be advantageously used. The size, the number, volume and position of the recessed portion or the protruding portion formed on the electrode shaft vary depending upon rating, size and volume of the mercury sealed in the arc tube; therefore studies such as previous tests are required. In addition, the lamp may be turned on in an inclined, horizontal posture and in any other postures with respect to the lamp axis.

Further, transverse or slanting cut groove may be formed on the electrode shaft surface spaced from the coiled electrode or a metal mesh may be wound so that the electrode shaft surface is roughed for storage of a large amount of mercury thereon.

A high-intensity discharge lamp according to an embodiment of the present invention can prevent mercury from adhering to a tip portion of a coiled electrode, thus improving startability such as shortening a start-up period. Discharge from mercury is inhibited; therefore, deterioration, exhaustion and consumption of mercury can be suppressed, thereby providing a high-intensity discharge lamp of high quality, such as a metal halide lamp.

In addition, a lighting device according to another embodiment of the present invention is provided with the high-intensity discharge lamp according to the embodiment, thereby providing a lighting device, such as a luminaire, excellent in quality such as startability and light-emitting characteristics.

Further, a lighting device (luminaire) according to another embodiment of the present invention can shorten a start-up period in a lighting device (luminaire) mounted with existing choke type ballast.

### BRIEF DESCRIPTION OF THE DRAWINGS

FIG. 1 is a front view of an outline structure of a high-intensity discharge lamp according to an embodiment of the present invention;

FIG. 2 is an enlarged longitudinal sectional view of an arc tube portion in FIG. 1;

FIGS. 3A to 3D are enlarged front views of a tip portion of an upper electrode structure in FIG. 2 and illustrate deposit states of mercury on the electrode structure with time after the lamp is turned off;

FIG. 4 is a longitudinal sectional view of an outline structure of a lighting device (luminaire) for a high ceiling to which the high-intensity discharge lamp illustrated in FIG. 1 is attached;

FIGS. 5A to 5D are enlarged front views of an essential part of an electrode structure according to another embodiment used for a high-intensity discharge lamp of the present invention and illustrate deposit states of mercury on the electrode structure with time after the lamp is turned off;

FIGS. 6A to 6F are enlarged front views of essential parts of electrode structures according to other embodiments used for a high-intensity discharge lamp of the present invention;

FIG. 7 is a front view of an arc tube according to another embodiment used for a high-intensity discharge lamp of the present invention;

FIG. 8 is a longitudinal sectional view of a structure of an essential part of a conventional arc tube; and

FIGS. 9A to 9D are enlarged front views of a tip portion of an upper electrode structure in FIG. 8 and are descriptive views illustrating deposit states of mercury on the electrode structure with time after the lamp is turned off.

### DETAILED DESCRIPTION

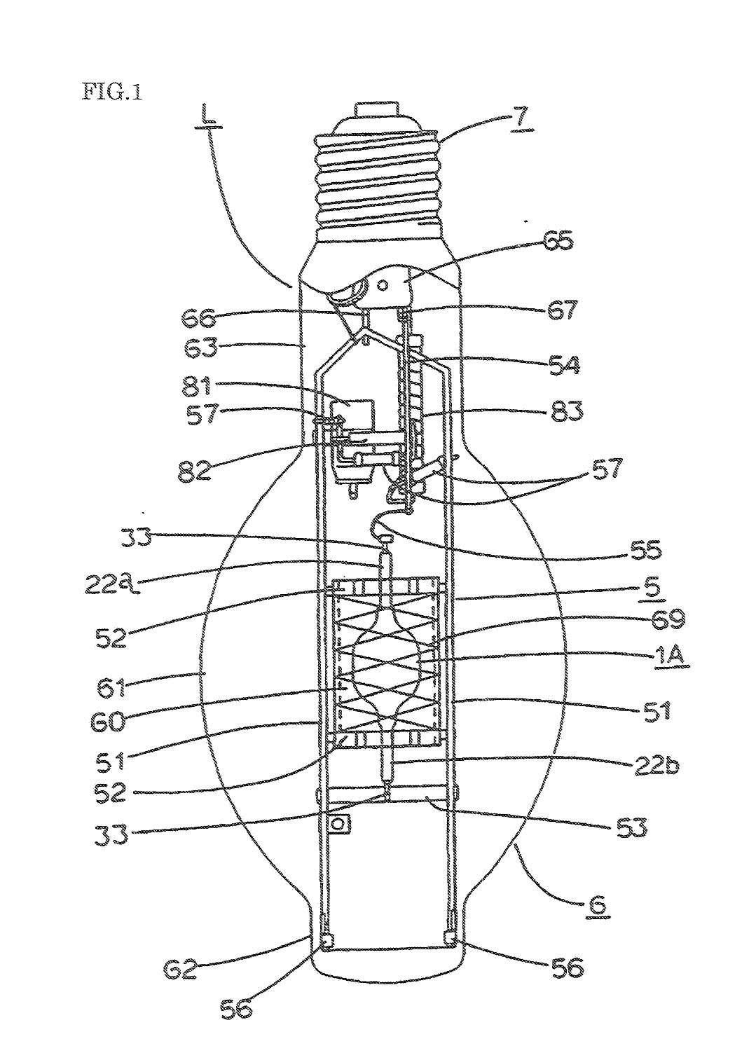

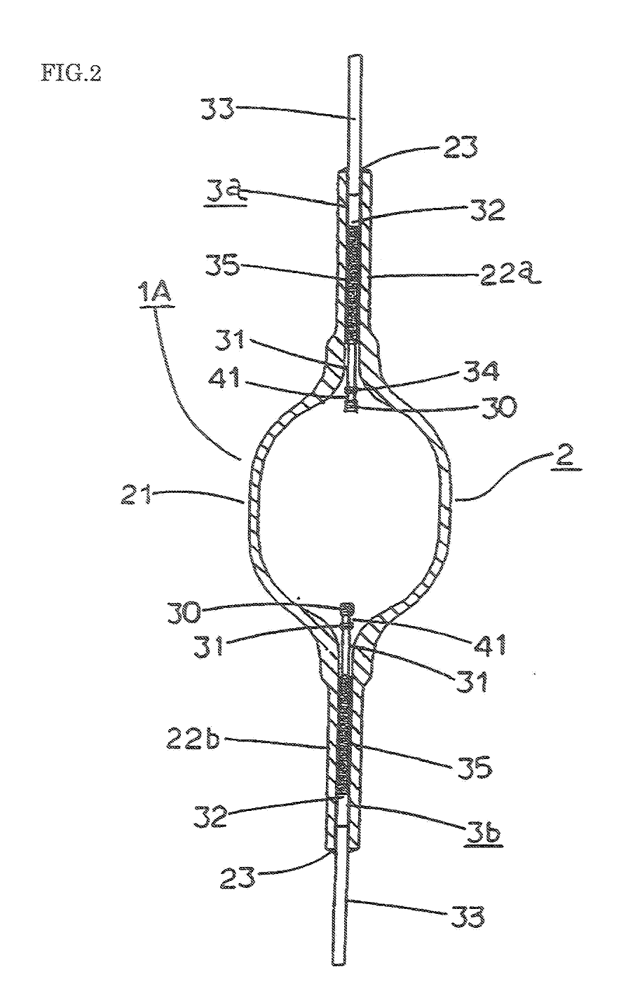

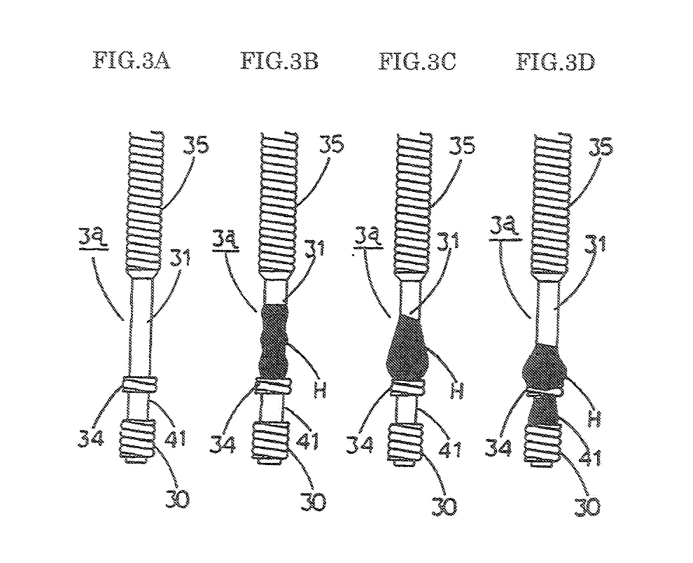

Embodiments of the present invention will be described in detail with reference to the accompanying drawings. FIG. 1 is a front view of an outline structure of a high-intensity discharge lamp according to an embodiment of the present invention. FIG. 2 is an enlarged longitudinal sectional view of an arc tube portion in FIG. 1. FIGS. 3A to 3D are enlarged front views of a tip portion of an upper electrode structure in FIG. 2 and illustrate deposit states of mercury on the electrode structure with time after the lamp is turned off.

A high-intensity discharge lamp L illustrated in FIG. 1 includes an arc tube 1A, a support member 5 supporting the arc tube 1A and constituting a power feeder, an outer bulb 6 housing the arc tube 1A and the support member 5 therein and a base 7 joined to an end portion of the outer bulb 6.

The arc tube 1A illustrated in FIG. 2 includes a discharge vessel 2 and electrode structures 3a, 3b. The discharge vessel 2 is made of ceramic material such as translucent alumina and constructed by integrally forming a swelling portion 21 substantially spherical in a longitudinal sectional shape with small-diameter tubular portions 22a, 22b joined by a curved surface continuous to both ends of the swelling portion. The electrode structures 3a, 3b are inserted into the small-diameter tubular portions 22a, 22b of the discharge vessel 2 and hermetically sealed with a heat-resistant sealant 23.

As illustrated in FIG. 2, each of the electrode structures 3a, 3b includes three members: an electrode shaft 31 made by a tungsten (W) wire; a lead-in conductor 32 made by a molybdenum (Mo) wire and constituting an intermediate member; and an outer conductor 33 made by a niobium (Nb) wire and serving as a sealing line. The three members are joined to each other in series by appropriate means such as butt-welding. On a tip portion of the electrode shaft 31, as illustrated in FIG. 3A, there are attached a coiled electrode 30 formed by closely winding approximately 5 turns (approximately 100% pitch) of a tungsten (W) fine wire and a coil 34 formed by closely winding approximately 2 turns of a tungsten fine wire at a position above the coiled electrode 30 and spaced from the coiled electrode 30 by approximately 4 turns. The lead-in conductor 32 is provided with a coil 35 formed by closely winding (approximately 100% pitch) a molybdenum (Mo) fine wire to ensure that the electrode structures 3a, 3b are centered in the small-diameter tubular portions 22a, 22b of the discharge vessel 2. Here, the coiled electrode 30 closely wound around the tip portion of the electrode shaft 31 and the coil 34 closely wound at a position above thereof and spaced therefrom by approximately 4 turns form protruding portions protruding from a peripheral surface of the electrode shaft 31, respectively and a relatively recessed portion 41 is formed on the electrode shaft 31 between the coiled electrode 30 and the coil 34.

As illustrated in FIG. 2, the electrode structures 3a, 3b inserted into the small-diameter tubular portions 22a, 22b are arranged so that the electrodes 30, 30 are opposed to each other at a predetermined discharge interval in the swelling portion 21. The outer conductors 33 of the electrode structures 3a, 3b are hermetically sealed in the small-diameter tubular portions 22a, 22b with the heat-resistant sealant 23.

In this case, a gap between each of inner faces of the small-diameter tubular portions 22a, 22b and each of outer faces of the lead-in conductors 32, around which the coils 35 are wound, is set to be 0.1 mm or less (they may be in contact with each other).

Starting and buffering gases including neon (Ne) and argon (Ar), for example, as a discharge medium, metal halide as light-emitting metal and mercury are charged in the discharge vessel 2 of the arc tube 1A. The metal halide includes sodium iodide (NaI), thallium iodide (TlI), indium iodide (InI) and thulium iodide (TmI₃), for example.

The outer bulb 6 is made of translucent hard glass such as borosilicate glass. As illustrated in FIG. 1, the outer bulb 6 is formed into a so-called BT type, which has a swelling portion 61 in a center thereof and a small-diameter top portion 62 with its lower end closed and a neck portion 63 on an upper side of FIG. 1. The neck portion 63 has a sealed portion (not illustrated) where a stem 65 is sealed. An E-type base 7 is attached to cover the sealed portion.

To a pair of internal lead-in wires 66, 67 extending from the stem 65 sealed in the outer bulb 6, the support member 5 for supporting the arc tube 1A is connected and fixed. That is to say, one internal lead-in wire 66 of a wire material or a plate material made of nickel, for example, is connected and fixed, by appropriate means such as welding, to a proximal end portion side of a support wire 51 formed into a substantially elongated U-shape, using the wire material in the present embodiment.

In addition, a pair of metal support plates 52, 52, attached so as to bridge the support wires 51 extending in parallel to each other at a middle portion of the support wire 51, support the arc tube 1A by pressing and holding the small-diameter tubular portions 22a, 22b, extending from both ends of the arc tube 1A, from the outside.

Further, a middle tube 60, made of silica glass and having a cylindrical shape with open upper and lower ends, for example, is fixed to the support plates 52, 52 herein, being spaced by a predetermined distance from the arc tube 1A. A reinforcing member 69 made of ceramics (such as alumina) is spirally wound around the middle tube 60.

The outer conductor 33 led out of the lower small-diameter tubular portion 22b of the arc tube 1A is electrically connected to a metal conductor plate 53 attached so as to bridge the support wires 51. On the other hand, the outer conductor 33 led out of the upper small-diameter tubular portion 22a is electrically connected, via a feeder line 55, with a conductor 54 connected to the other internal lead-in wire 67.

With such a structure, supporting of the arc tube 1A and the middle tube 60 is not complete. Accordingly, metal blade-like elastic (spring) members 56, 56 in elastic contact with an inner wall of the top portion 62 may be attached to a side surface in the vicinity of a tip portion of the support wire 51 extending into the small-diameter top portion 62 of the outer bulb 6. The elastic (spring) members 56, 56 can support the arc tube 1A so as to be positioned on a central axis of the outer bulb 6.

A start assisting circuit is connected in parallel to the upper and lower electrodes 30, 30 in the arc tube 1A. The start assisting circuit includes a glow starter for start-up 81, a thermally-actuated switch 82 using a bimetal and a resistor 83.

Bridge members 57, 57 are made of an electrical insulating material and bridge the support wire 51, the thermally-actuated switch 82 and the resistor 83 for reinforcement thereof. The bridge member 57 constitutes the support member 5 together with the support wire 51, the support plates 52, 52, the conductor plate 53 and the elastic (spring) members 56, 56. In addition to the elastic (spring) members 56, 56, an elastic (spring) member in elastic contact with the inner wall of the small-diameter neck portion 63 may be attached to support the support wire 51.

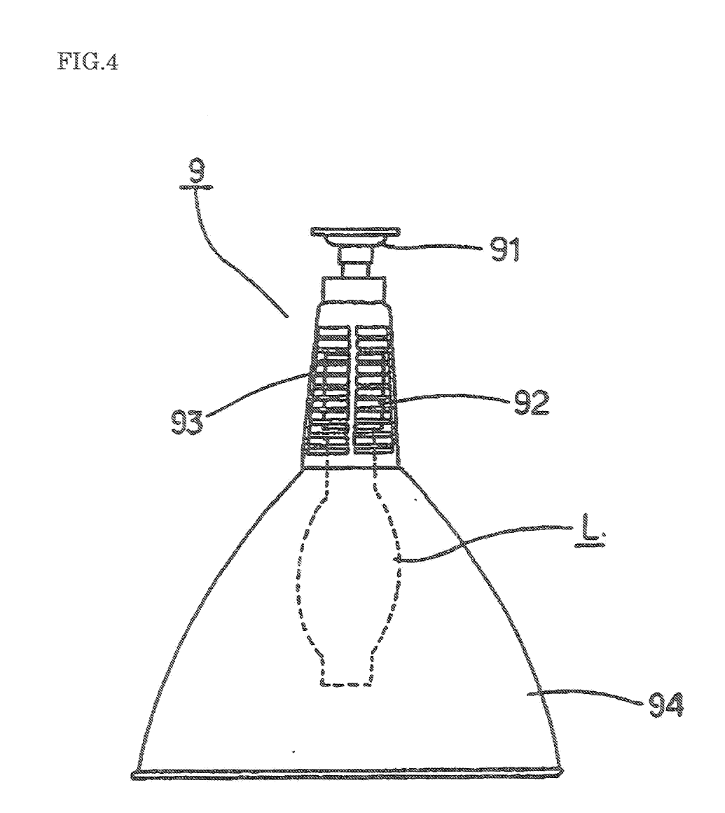

The high-intensity discharge lamp illustrated in FIG. 1 is attached to a lighting device (luminaire) 9 for illumination illustrated in FIG. 4, for example, as a metal halide lamp L of a double-tube structure which houses the arc tube 1A in the BT-type outer bulb 6.

FIG. 4 is a longitudinal sectional view illustrating an embodiment of the lighting device (luminaire) for a high ceiling to which the high-intensity discharge lamp L is attached. In the luminaire 9 illustrated in FIG. 4, a socket 92 is attached to a support base 91 serving as a mounting portion to a ceiling surface or the like. A guard 93 is provided around the socket 92. At a lower end of the guard 93, there is fixed a conical reflecting shade 94 which is made of a metal plate or enamel and has an inner surface as a reflecting surface. When the base 7 of the discharge lamp L is inserted in the socket 92, supporting of lamp and electrical connection are achieved. Although not illustrated in the present embodiment, alighting circuit device using choke ballast and a power switch of the discharge lamp L are provided separately from the luminaire body 91.

The lighting device (luminaire) 9 is attached to a ceiling surface of sports facilities; for example, so that the support base 91 is attached to the ceiling surface with an opening side of the reflecting shade 94 faces downward. The lighting device (luminaire) 9 is of a so-called base-up type, in which the discharge lamp L is inserted in the socket 92 in a substantially vertical state with the base 7 at the top. When a power switch (not illustrated) of the lighting device (luminaire) 9 is turned on, the discharge lamp L is energized by a power supply via the lighting circuit device and the socket 92.

At starting up of the discharge lamp L, a voltage is applied to both electrodes 30, 30 and both terminals of the glow starter 81 connected in parallel via a terminal of the base 7, through the lead-in wires and the electrode structure 5. A discharge is generated between discharge electrodes made of bimetal in the glow starter 81 with low resistance, low impedance and the smallest distance therebetween due to the voltage application, so that ultraviolet rays are radiated, with which the electrodes 30, 30 in the arc tube 1A are irradiated.

With the additional operation of this ultraviolet ray radiation, electrons are released from surfaces of the both electrodes 30, 30 and the initial number of electrons increases, thus attaining increased discharge. Then, the bimetal in the glow starter 81 comes in contact due to a thermal actuation resulting from the discharge, thereby stopping the discharge. At the moment the bimetal cools down due to the discharge stop and the electrodes separate from each other, high-voltage pulses occur at the ballast of the lighting circuit device, which are applied to the electrodes 30, 30. By the application of the high-voltage pulses, a discharge is generated between the electrodes 30, 30 to start up the lamp L and subsequently, a stable turning-on state is maintained.

After predetermined time of illumination, the discharge lamp L is turned off by switching off the power switch (not illustrated) of the lighting device (luminaire) 9.

In the discharge lamp L according to the embodiment of the present invention, mercury H adheres to the upper electrode structure 3a in the discharge vessel 2 with time after turning off of the discharge lamp L by turning the power switch off. The inventors of the present invention observed the mercury deposition with an X-ray camera. As a result, mercury deposition states as illustrated in FIGS. 3A to 3D were observed. Specifically, FIG. 3A illustrates a mercury deposition state immediately after turning-off. FIG. 3B illustrates a mercury deposition state approximately four minutes after turning-off. FIG. 3C illustrates a mercury deposition state approximately six minutes after turning-off. And FIG. 3D illustrates a mercury deposition state approximately eight minutes after turning-off.

Under a high-temperature atmosphere immediately after turning-off, as illustrated in FIG. 3A, most of mercury having a high vapor pressure is vaporized, so that deposition of liquid mercury on the electrode shaft 31 or the like is not found. Approximately four minutes after turning-off, as illustrated in FIG. 3B, the vaporized mercury in contact with a surface of the electrode shaft 31 having a small heat capacity is cooled down at a portion having a smallest diameter of the electrode structure 3a between the coil 34, in which is closely wound by approximately 2 turns and the coil 35, becomes liquefied mercury H and falls down to a top face of an end portion of the coil 34 on a lower side.

Approximately 6 minutes after turning-off, as illustrated in FIG. 3C, liquefied mercury H gathers in a teardrop form on the top face of the end portion of the coil 34. At approximately 8 minutes after turning-off, as illustrated in FIG. 3D, the vaporized mercury is gradually cooled down on the electrode shaft 31, so that the liquefied mercury increases in volume. The increased mercury gathers on the top face of the end portion of the coil 34, and the resulting overflowing liquefied mercury H falls down across a surface of the coil 34 and flows into the recessed portion 41 between the coil 34 and the coiled electrode 30 with no coil thereon. Thus, liquefied mercury H can be gathered in the recessed portion 41 and the mercury H can be suppressed from adhering to a tip portion of the electrode 30 forming a discharge trigger.

Specifically, in the high-intensity discharge lamp L using the electrode structure 3a having the structure described above, after turning-off of the lamp L that was turned on in a vertical state, cooled-down and liquefied mercury H flows into and stored in the recessed portion 41 formed on the electrode shaft 31 between the coil 34 wound at a middle portion of the electrode shaft 31 and the coiled electrode 30.

Accordingly, since the recessed portion 41 stores the liquefied mercury H as a storage portion for liquefied mercury H, deposition of the liquefied mercury H in a manner blocking discharge at the tip portion of the electrode 30 can be suppressed. Accordingly, at starting up of the lamp L, a discharge can be generated from the material forming the electrode 30, and thus the start-up time of the lamp L can be shortened. Because a discharge is not blocked by mercury H, alteration or deterioration and exhaustion of the electrode material can be suppressed, improving the quality of the high-intensity discharge lamp L and the lighting device (luminaire), such as stable discharge and longer life time.

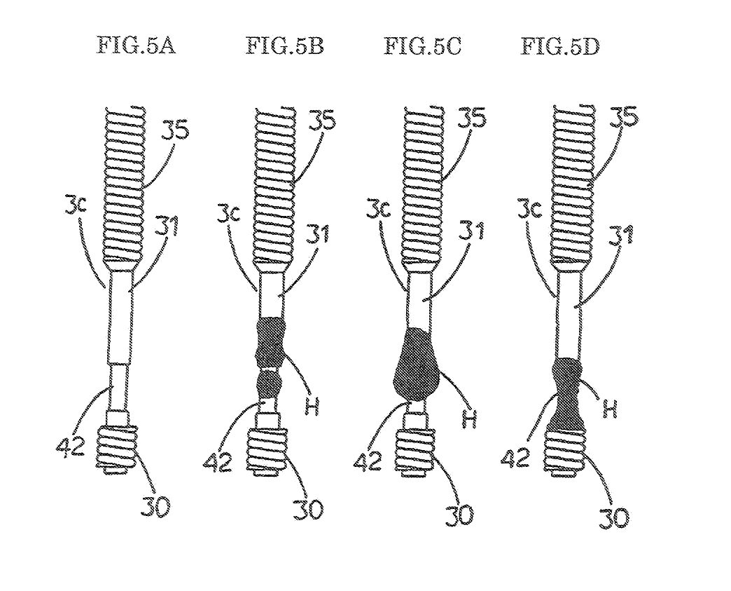

FIGS. 5A to 5D are enlarged front views of an essential part of an electrode structure according to another embodiment used for a high-intensity discharge lamp of the present invention and illustrate deposition states of mercury on the electrode structure with time after the lamp is turned off. FIGS. 5A to 5D illustrate deposition states of mercury with the same amounts of time after the lamp is turned off as FIGS. 3A to 3D, respectively and therefore, the same components as in FIG. 3 are assigned the same reference symbols and the description thereof is not repeated.

In an electrode structure 3c illustrated in FIGS. 5A to 5D, as illustrated in FIG. 5A, a portion of the electrode shaft 31 which is lower than a portion having a wound coil 35 and is nearer to the coiled electrode 30 is reduced in diameter, thereby forming a recessed portion 42. As illustrated in FIG. 5B, the electrode structure 3c, approximately minutes after turning-off, vaporized mercury adheres to the electrode shaft 31 which has a smallest diameter and a smallest heat capacity of the electrode structure 3c and a surface in the vicinity of the recessed portion 42 and is cooled down to become liquefied mercury H. Subsequently, approximately 6 minutes after turning-off, the liquefied mercury H illustrated in FIG. 5C falls down and flows into the recessed portion 42 in a teardrop form.

Then, approximately 8 minutes after turning-off, as illustrated in FIG. 5D, vaporized mercury gradually adheres to the electrode shaft 31, so that liquefied mercury increases and mercury H overflowing from the recessed portion 42 falls down to the top face of the end of the coiled electrode 30. However, the flow of mercury is blocked on the top face of the end of the coiled electrode 30 of a large diameter protruding from a peripheral surface of the electrode shaft 31, thereby gathering the mercury on the top face of the end. Thus, the mercury H can be suppressed from adhering to the tip portion of the electrode 30 forming a discharge trigger.

The recessed portion 42 formed at a middle portion of the electrode shaft 31 in the electrode structure 3c may be formed by cutting the electrode shaft 31 to be reduced in diameter or connecting a metal member of a smaller diameter to the middle portion of the electrode shaft 31.

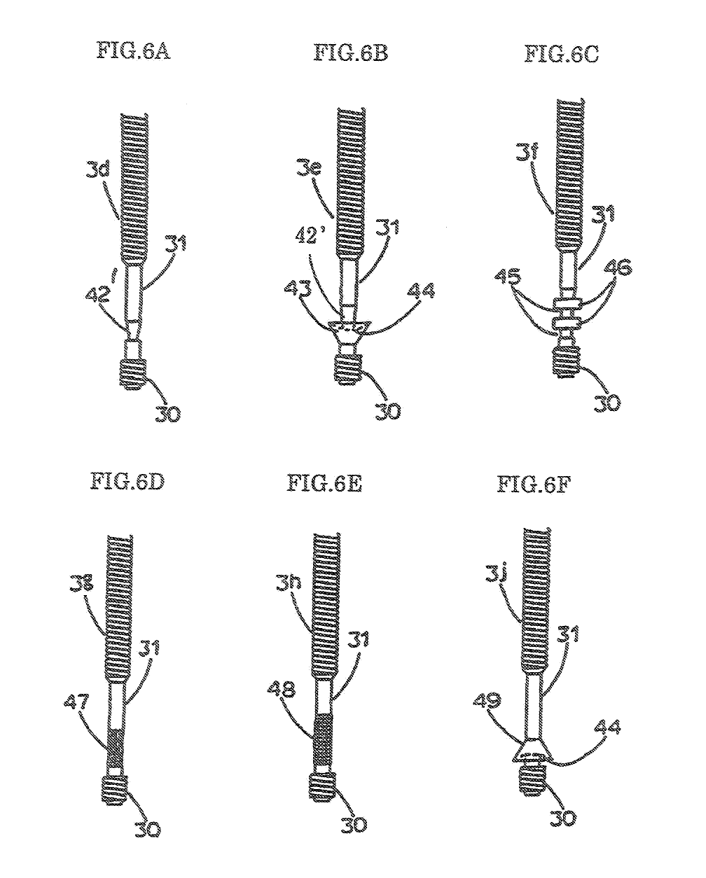

FIGS. 6A to 6F are enlarged front views of essential parts of electrode structures according to other embodiments used for a high-intensity discharge lamp of the present invention. In FIGS. 6A to 6E, the same components as the electrode structure illustrated in FIG. 3 or FIG. 5 are assigned the same reference symbols and the description thereof is not repeated.

An electrode structure 3d illustrated in FIG. 6A has a similar structure to the electrode structure 3c illustrated in FIG. 5 except for that the electrode shaft 31 is formed with a tapered recessed portion 42′. Liquefied mercury smoothly falls down to the tapered recessed portion 42′ to be stored therein.

An electrode structure 3e illustrated in FIG. 6B has a structure similar to the electrode structure 3d illustrated in FIG. 6A except for that a protruding portion 43 of an inverted conical shape is formed below a tapered recessed portion 42′ on the electrode shaft 31. Liquefied mercury can be stored on a top face of the protruding portion 43. In addition, a recessed portion 44 as illustrated by broken lines may be formed on a top face side of the inverted conical protruding portion 43, thus storing a larger amount of liquefied mercury. Liquefied mercury overflowing from the top face of the inverted conical protruding portion 43 is stored on the top face of the coiled electrode 30.

An electrode structure 3f illustrated in FIG. 6C is formed with recessed portions 45, 45 and protruding portions 46, 46 arranged alternately on the electrode shaft 31, thus storing a larger amount of liquefied mercury in the plurality of recessed portions 45, 45. The number of the recessed portions 45, 45 and the protruding portions 46, 46 may be two or more, respectively.

An electrode structure 3g illustrated in FIG. 6D is formed with a slit 47 in a longitudinal, transverse or slanting direction on a peripheral surface of the electrode shaft 31 to increase a surface area of the electrode shaft 31, thus storing a larger amount of liquefied mercury.

In an electrode structure 3h illustrated in FIG. 6E, a metal mesh 48 is wound around a surface of the electrode shaft 31 to increase a surface area thereof, thus storing a larger amount of liquefied mercury.

An electrode structure 3j illustrated in FIG. 6F has a similar structure to that in FIG. 6B and the electrode shaft 31 is formed with a conical protruding portion 49 having a larger diameter than an outer diameter of the coiled electrode 30. The mercury liquefied by being in contact with the electrode shaft 31 smoothly falls down along a top surface of a protruding portion 49 and drops outward of the electrode structure 3j without hitting the electrode 30, thereby preventing mercury from remaining on the electrode 30. In the electrode structure 3j, the electrode shaft 31 is formed into the same diameter and no tapered recessed portion is formed.

As described above, the respective electrode structures 3c to 3j illustrated in FIG. 5A and FIGS. 6A to 6F can suppress liquefied mercury H from adhering to the coiled electrode 30 forming a discharge trigger after turning-off by forming recessed portions 42′, 44, 47, protruding portions 43, 46, 49 or a mesh 48 on the electrode shaft 31. Thus, each of the embodiments also provides a high-intensity discharge lamp and a lighting device (luminaire), capable of exhibiting the same operation and advantageous effects as the embodiments illustrated in FIGS. 1 to 3.

The recessed portions formed on the electrode shaft 31 in the above-described electrode structures 3a to 3h are formed to serve as a storage portion for mercury. On the other hand, the protruding portion in the electrode structure 3j illustrated in FIG. 6F is formed to serve as a falling-down portion for mercury to positively drop mercury along a conical inclined surface. The recessed portions and the protruding portions may reversely serve as the falling-down portions and the storage portions for mercury, depending upon a direction along which the lamp is mounted. In addition, the recessed portion and the protruding portion are relative concepts and, for example, if a recessed portion is formed, a protruding portion as well is inevitably generated.

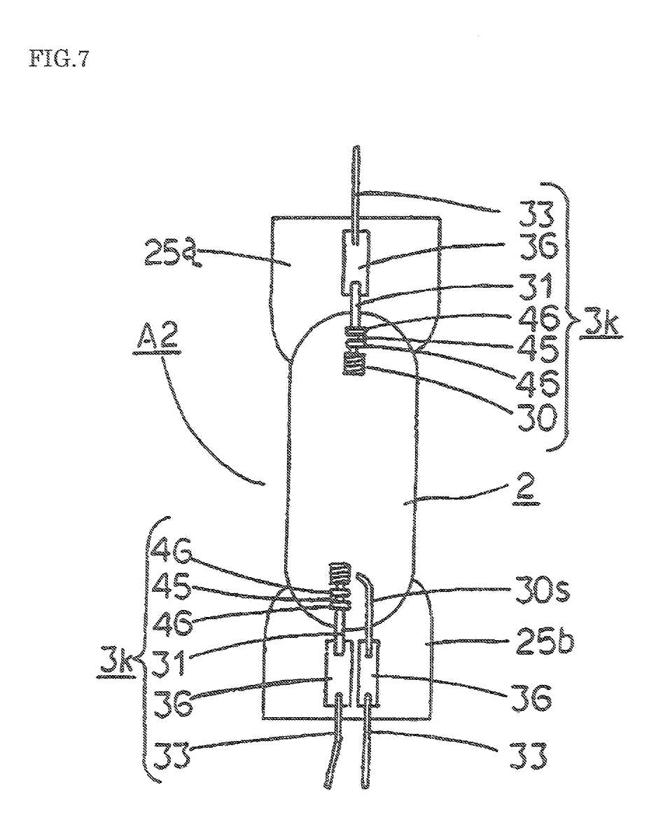

FIG. 7 is a front view of an arc tube according to another embodiment used for a high-intensity discharge lamp of the present invention. In FIG. 7, the same components as in FIG. 2 are assigned the same reference symbols and the description thereof is not repeated. An electrode structure 3k used in an arc tube A2 according to the embodiment of the present invention includes an electrode shaft 31 made of a tungsten (W) or molybdenum (Mo) wire connected with one end of sealing metal 36 made of a molybdenum (Mo) foil or the like and an external conductor 33 made of a molybdenum (Mo) wire connected with the other end of the sealing metal 36. The electrode shaft 31 as a main electrode has protruding portions 46, 46 similar to those of the electrode structure illustrated in FIG. 6C and a recessed portion 45 formed therebetween.

On both ends of a straight silica glass tube constituting the discharge vessel 2, upper and lower sealed portions 25a, 25b are formed by thermally pressing end portions thereof. There are provided a set of electrode structure 3k in the upper sealed portion 25a. Another set of electrode structure 3k and a start assisting electrode 30s are hermetically sealed in parallel to each other in the lower sealed portion 25b, respectively. Mercury and argon (Ar) are charged in the discharge vessel 2, which is further sealed in the outer bulb to form a high-intensity mercury lamp (not illustrated).

The high-intensity mercury lamp also provides improved startability without adhesion of liquefied mercury to tip portions of the coiled electrodes 30, after turning-off. In the lower electrode structure 3k, liquefied mercury is stored in the recessed portion and on the protruding portions 46, 46. An electrical short due to gathering liquefied mercury between roots of the electrode structure 3k and the assist electrode 30s is prevented, thereby preventing generation of troubles such as no lighting-up. Specific example of the present invention will be described below in detail.

### First Example

An arc tube 1A of a structure illustrated in FIG. 2 is sealed in an outer bulb 6 of a lamp L illustrated in FIG. 1.

A discharge vessel 2, made of alumina, of the arc tube 1A is approximately 20 mm in a maximum inner diameter and approximately 25 mm in an inner length at a central portion, and approximately 1.5 mm in an inner diameter and approximately 25 mm in an inner length of each of small-diameter tubular portions 22a, 22b.

Each of the electrode structures 3a, 3b has substantially the same structure as in FIG. 3 and the electrode shaft 31 made of tungsten (W) wire is approximately 0.75 mm in an outer diameter and approximately 7 mm in a length. On the tip portion of each electrode shaft 31, there are provided a coiled electrode 30 around which a tungsten (W) wire of approximately 0.3 mm in an outer diameter is wound by 5 or 6 turns and a coil 34 around which the wire is wound by approximately 2 turns, being spaced from the end face of the coiled electrode 30 by approximately 0.5 mm.

A distance between the coiled electrodes 30, 30 opposed to each other on the tip portions of the electrode structures 3a, 3b is approximately 18 mm. A portion of the electrode shaft 31 between the coiled electrode 30 and the coil 34 is approximately 0.5 mm in a length and approximately 0.3 mm in a depth and a recessed portion 41 for storing mercury is formed at this portion.

In the discharge vessel 2, there is charged, as an ionizable charged material, argon (Ar) gas of approximately 100 torr, mercury of approximately 50 mg and approximately 10 mg of NaI—TlI—TmI₃—InI of 50:15:25:10 in a weight ratio.

### Second Example

A lamp according to the second example is a ceramic metal halide lamp having the same rating and structure as the first example but has an electrode structure having the same structure as in FIG. 5. Specifically, the recessed portion 42 formed on the electrode shaft 31 (outer diameter: approximately 0.75 mm) in the vicinity of the coiled electrode 30 in the electrode structure is approximately 1.5 mm in an axial length and approximately 0.55 mm in an outer diameter (depth: approximately 0.1 mm).

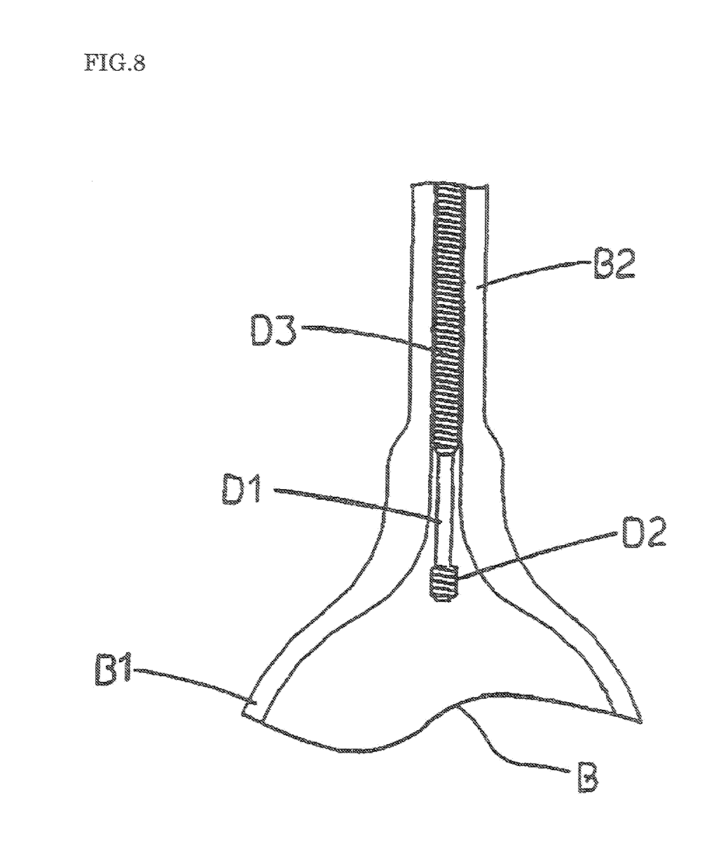

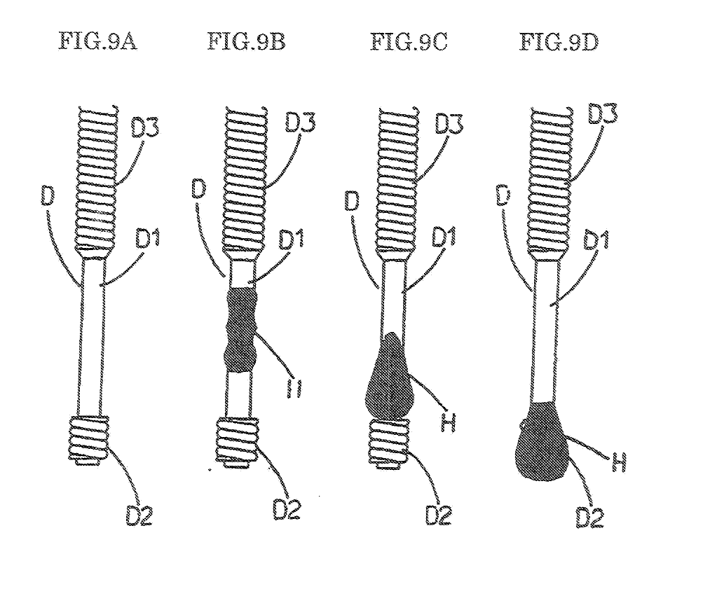

The inventors of the present invention fabricated ceramic metal halide lamps according to the first and second examples and a ceramic metal halide lamp of the same rating and structure as those of the first example except for the electrode structure for comparative use, and examined characteristics thereof, such as startability. The lamp for comparative use has an electrode structure D having the conventional structure illustrated in FIGS. 8 and 9.

Table 1 shows measurement results of the lamps having the three types of electrode structures (4 lamps for each type), which were obtained by reducing a power voltage of a mercury lamp with a rated power voltage of 200 V to 180 V using choke ballast of 300 W and measuring each start period (time (second) required to start an arc discharge after a glow discharge).

For measurement of the start-up time, each lamp was turned off after over 20 minutes' illumination and was left at room temperature for over 4 hours.

As shown in Table 1, a lamp equipped with the electrode structure having a recessed portion and a protruding portion on an electrode shaft has achieved a good result of a shorter start-up period by a few seconds than a lamp equipped with the conventional electrode structure.

TABLE 1

| LAMP TYPE | | | |
|---|---|---|---|
| [FIGURE OF | FIRST | SECOND | CONVENTIONAL |
| ELECTRODE | EXAMPLE | EXAMPLE | EXAMPLE |
| STRUCTURE] | [FIG. 3] | [FIG. 5] | [FIG. 9] |
| NO. 1 | 7.0 SECONDS | 4.4 SECONDS | 8.4 SECONDS |
| NO. 2 | 6.9 SECONDS | 6.8 SECONDS | 7.8 SECONDS |
| NO. 3 | 5.9 SECONDS | 6.0 SECONDS | 8.0 SECONDS |
| NO. 4 | 6.5 SECONDS | 4.7 SECONDS | 10.7 SECONDS |
| AVERAGE | 6.6 SECONDS | 5.5 SECONDS | 8.7 SECONDS |

Table 2 shows remeasurement results of start periods of the same lamps under the same conditions. From the table, reproducibility was verified with the same tendency as in Table 1.

TABLE 2

| LAMP TYPE | | | |
|---|---|---|---|
| [FIGURE OF | FIRST | SECOND | CONVENTIONAL |
| ELECTRODE | EXAMPLE | EXAMPLE | EXAMPLE |
| STRUCTURE] | [FIG. 3] | [FIG. 5] | [FIG. 9] |
| NO. 1 | 7.6 SECONDS | 4.0 SECONDS | 9.2 SECONDS |
| NO. 2 | 6.4 SECONDS | 5.5 SECONDS | 8.2 SECONDS |
| NO. 3 | 4.6 SECONDS | 4.6 SECONDS | 6.4 SECONDS |
| NO. 4 | 7.1 SECONDS | 4.4 SECONDS | 9.7 SECONDS |
| AVERAGE | 6.4 SECONDS | 4.6 SECONDS | 8.4 SECONDS |

Table 3 shows measurement results of lumen maintenance factors of the same lamps under the same conditions. Specifically, the lumen maintenance factors in Table 3 were obtained by turning on the lamps for 3,000 hours and 6,000 hours each in on-off cycles of 6 hours in total, each cycle including turning-on period of 5.5 hours and turning-off period of 0.5 hours, and measuring the resulting luminous flux degradation.

TABLE 3

| LAMP TYPE | | | |
|---|---|---|---|
| [FIGURE OF | FIRST | SECOND | CONVENTIONAL |
| ELECTRODE | EXAMPLE | EXAMPLE | EXAMPLE |
| STRUCTURE] | [FIG. 3] | [FIG. 5] | [FIG. 9] |
| 3,000 HRS | 67% | 68% | 62% |
| 6,000 HRS | 58% | 60% | 50% |

The measurement results indicate that the lumen maintenance factors of the high-intensity discharge lamps of the first and second examples have been improved by 5 to 6 points for 3,000 hours and 8 to 10 points for 6,000 hours than those in the high-intensity discharge lamp of the conventional example. This may be because in the high-intensity discharge lamps according to the first and the second examples, liquefied mercury does not adhere to a tip portion of an electrode shaft, which reduces sputtering of an electrode material in starting a discharge, thereby to improve the lumen maintenance factor.

The present invention is not limited to the embodiments described above and various modifications and applications are possible. For example, the high-intensity discharge lamp is also applicable to other types of discharge lamps, without being limited to metal halide lamps and mercury lamps and provides a substantially same operation and advantageous effects as the embodiments above.

In addition, the lighting device (luminaire) is also applicable to other structures and applications without being limited to the embodiments above. Further, the discharge lamp is also applicable where the installation direction of the discharge lamp is a slanting direction as well without being limited to perpendicular installation such as base-up or base-down installation

What is claimed is:

1. A high-intensity discharge lamp comprising an arc tube including:
a heat-resistant translucent discharge vessel forming a discharge space;
an electrode structure including an electrode shaft hermetically sealed at each of opposed end portions of the discharge vessel and having a tip portion disposed in the discharge vessel, a coiled electrode wound around the tip portion of the electrode shaft disposed in the discharge vessel, and a recessed portion or a protruding portion formed on the electrode shaft spaced from the coiled electrode; and
a discharge medium charged in the discharge vessel, the discharge medium being composed of a light-emitting metal including mercury and a starting gas.

2. The high-intensity discharge lamp according to claim 1, further comprising:
a support member electrically connected with the electrode structure of the arc tube and holding the arc tube; and
an outer bulb having the arc tube disposed therein along a tube axis and sealed with a support member at an end portion thereof.

3. The high-intensity discharge lamp according to claim 2, wherein the recessed portion or the protruding portion formed on the electrode shaft is formed by a coil wound around the electrode shaft.

4. The high-intensity discharge lamp according to claim 2, wherein the recessed portion or the protruding portion formed on the electrode shaft is formed by partially varying an outer diameter of the electrode shaft.

5. The high-intensity discharge lamp according to claim 4, wherein the recessed portion or the protruding portion formed on the electrode shaft is formed by connecting the electrode shaft with an electrode shaft having a different outer diameter.

6. The high-intensity discharge lamp according to claim 1, wherein the discharge vessel is made of ceramics material having a substantially spherical swelling portion and a small-diameter tubular portion formed integrally therewith at each of both ends of the swelling portion, and the electrode structure is inserted into the small-diameter tubular portion and hermetically sealed with a heat-resistant sealant.

7. The high-intensity discharge lamp according to claim 6, wherein a centering coil is wound around the electrode structure at a portion disposed in the small-diameter tubular portion.

8. The high-intensity discharge lamp according to claim 6, further comprising:
a support member electrically connected with the electrode structure of the arc tube and holding the arc tube; and
an outer bulb having the arc tube disposed therein along a tube axis and sealed with a support member at an end portion thereof.

9. The high-intensity discharge lamp according to claim 8, wherein the recessed portion or the protruding portion formed on the electrode shaft is formed by a coil wound around the electrode shaft.

10. The high-intensity discharge lamp according to claim 8, wherein the recessed portion or the protruding portion formed on the electrode shaft is formed by partially varying an outer diameter of the electrode shaft.

11. The high-intensity discharge lamp according to claim 10, wherein the recessed portion or the protruding portion formed on the electrode shaft is formed by connecting the electrode shaft with an electrode shaft having a different outer diameter.

12. A lighting device comprising:
a lighting device body;
the high-intensity discharge lamp according to any one of claims 3, 4, 9 and 10 provided in the lighting device body; and
lighting circuit means for turning on the high-intensity discharge lamp.

13. The lighting device according to claim 12, wherein the lighting circuit means for turning on a lamp is attached with choke ballast.
